(19) United States
(12) Patent Application Publication
(10) Pub. No.: US 2024/0160065 A1
(43) Pub. Date: May 16, 2024

(54) DISPLAY PANEL, DISPLAY DEVICE, AND SPLICING DISPLAY DEVICE

(71) Applicant: TCL China Star Optoelectronics Technology Co., Ltd., Shenzhen (CN)

(72) Inventor: Mingshen ZHAO, Shenzhen (CN)

(21) Appl. No.: 17/785,546

(22) PCT Filed: May 26, 2022
(86) PCT No.: PCT/CN2022/095163

§ 371 Date: Jun. 15, 2022

(30) Foreign Application Priority Data
May 19, 2022 (CN) 202210557648.3

(51) Int. Cl. G02F 1/1339; G02F 1/1333; G02F 1/1335; G02F 1/1343

(52) U.S. Cl. CPC G02F 1/1339; G02F 1/133302; G02F 1/133311; G02F 1/133514; G02F 1/134309

(57) ABSTRACT

The present application provides a display panel, a display device, and a splicing display device. The display panel includes a first substrate, a second substrate disposed opposite to the first substrate, a liquid crystal layer sandwiched between the first substrate and the second substrate, and a flexible circuit board bound and connected to the second substrate; the first substrate includes a common electrode layer at least disposed corresponding to the liquid crystal layer; the second substrate includes an array layer and a color filter layer located on a side of the array layer away from the liquid crystal layer; the flexible circuit board is located on a side of the array layer close to the liquid crystal layer.

### BACKGROUND OF INVENTION

### Field of Invention

The present invention relates to a field of display technology, and specifically to a display panel, a display device, and a splicing display device.

### Description of Prior Art

In recent years, with continuous development of liquid crystal display (LCD) display industry, an appearance of panels tends to narrow gradually. For example, narrow-frame TVs are to narrow a non-display area of edges, and a frame adopts a more concise and detailed shape to make products more beautiful.

In manufacturing processes of LCDs, to meet needs of liquid crystal driving, a binding position of driving circuits (such as chip on film, COF) needs to be reserved. A traditional method is to dispose a binding end of a side of an array substrate longer than a binding end of a side of a color filter (CF) substrate, so it is necessary to retain a specialized frame or a sealant to cover connecting circuits in a binding area; however, the above design cannot achieve a narrow-frame display.

### SUMMARY OF INVENTION

The present application provides a display panel, a display device, and a splicing display device, which can visually achieve a narrow-frame display, and is conducive to improving a display effect.

In a first aspect, the present application provides a display panel, which includes a first substrate, a second substrate disposed opposite to the first substrate, a liquid crystal layer sandwiched between the first substrate and the second substrate, and a flexible circuit board bound and connected to the second substrate;
wherein the first substrate includes a common electrode layer at least disposed corresponding to the liquid crystal layer; the second substrate includes a first area and a second area located at a side of the first area, and includes an array layer located in the first area and the second area and a color filter layer located on a side of the array layer away from the liquid crystal layer; the first substrate is disposed corresponding to the first area; and
the flexible circuit board is bound and connected to the array layer located in the second area, and the flexible circuit board is located on a side of the array layer close to the liquid crystal layer.

In the display panel provided by the present application, the second substrate further includes a transparent substrate located between the array layer and the color filter layer.

In the display panel provided by the present application, the transparent substrate includes a first transparent substrate and a second transparent substrate superimposed with each other; the first transparent substrate is located between the array layer and the second transparent substrate, and the second transparent substrate is located between the first transparent substrate and the color filter layer.

In the display panel provided by the present application, the display panel further includes a protective layer located on a side of the color filter layer away from the transparent substrate.

In the display panel provided by the present application, the second substrate further includes a transparent substrate located on a side of the color filter layer away from the array layer.

In the display panel provided by the present application, the color filter layer includes a plurality of color resist units disposed in an array in the first area and a light shielding layer located in the first area and the second area and located between any two adjacent ones of the color resist units.

In a second aspect, the present application further provides a display device, which includes the above display panel and a backlight module; wherein the backlight module is located on a side of the first substrate away from the second substrate; a part of the flexible circuit board away from the array layer is bent to fixedly connect to the backlight module.

In the display device provided by the present application, the display device further includes a frame located on sides of the display panel and the backlight module and a sealant located between the display panel and the frame; the sealant partially covers the second area.

In the display device provided by the present application, the second substrate further includes a transparent substrate located between the array layer and the color filter layer.

In the display device provided by the present application, the transparent substrate includes a first transparent substrate and a second transparent substrate superimposed with each other; the first transparent substrate is located between the array layer and the second transparent substrate, and the second transparent substrate is located between the first transparent substrate and the color filter layer.

In the display device provided by the present application, the display panel further includes a protective layer located on a side of the color filter layer away from the transparent substrate.

In the display device provided by the present application, the second substrate further includes a transparent substrate located on a side of the color filter layer away from the array layer.

In the display device provided by the present application, the color filter layer includes a plurality of color resist units disposed in an array in the first area and a light shielding layer located in the first area and the second area and located between any two adjacent ones of the color resist units.

In a third aspect, the present application further provides a splicing display device, which includes a plurality of splicing monomers spliced together; each of the splicing monomers includes the display panel mentioned above and a backlight module corresponding to the display panel;
wherein the backlight module is located on a side of a corresponding first substrate away from the second substrate; a part of the flexible circuit board away from the array layer is bent to fixedly connect to the corresponding backlight module.

In the splicing display device provided by the present application, one of the splicing monomers further includes a frame located on sides of the display panel and the backlight module, and a sealant located between the display panel and the frame; the sealant partially covers the second area.

In the splicing display device provided by the present application, the second substrate further includes a transparent substrate located between the array layer and the color filter layer.

In the splicing display device provided by the present application, the transparent substrate includes a first transparent substrate and a second transparent substrate superimposed with each other; the first transparent substrate is located between the array layer and the second transparent substrate, and the second transparent substrate is located between the first transparent substrate and the color filter layer.

In the splicing display device provided by the present application, the display panel further includes a protective layer located on a side of the color filter layer away from the transparent substrate.

In the splicing display device provided by the present application, the second substrate further includes a transparent substrate located on a side of the color filter layer away from the array layer.

In the splicing display device provided by the present application, the color filter layer includes a plurality of color resist units disposed in an array in the first area and a light shielding layer located in the first area and the second area and located between any two adjacent ones of the color resist units.

Compared with the prior art, in the display panel, the display device, and the splicing display device provided by the present application, the array layer and the color filter layer are disposed on a same side of the liquid crystal layer, the common electrode layer is disposed on another side of the liquid crystal layer, and the flexible circuit board is bound on the side of the array layer close to the liquid crystal layer, so as to avoid exposing a binding position to a display surface and a side of the display panel, thereby avoiding disposing a shielding structure for shading the flexible circuit board located at the binding position of the display surface of the display panel, which can effectively narrow a frame of the display panel visually to achieve the narrow-frame display.

### BRIEF DESCRIPTION OF DRAWINGS

FIG. 1 is a schematic structural diagram of an exemplary LCD display device.

FIG. 2 is a partial schematic structural diagram of a display panel provided by an embodiment of the present application.

FIG. 3 is a schematic structural diagram of a first substrate provided by the embodiment of the present application.

FIG. 4 is a partial schematic structural diagram of another display panel provided by an embodiment of the present application.

FIG. 5 is a partial schematic structural diagram of another display panel provided by an embodiment of the present application.

FIG. 6 is a partial schematic structural diagram of another display panel provided by an embodiment of the present application.

FIG. 7 is a schematic structural diagram of a display device provided by an embodiment of the present application.

FIG. 8 is a schematic structural diagram of a splicing display device provided by an embodiment of the present application.

### DETAILED DESCRIPTION OF EMBODIMENTS

Technical schemes in embodiments of the present application will be clearly and completely described below in combination with accompanying drawings in the embodiments of the present application. Obviously, the described embodiments are only part of the embodiments of the present application, not all of the embodiments. Based on the embodiments in the present application, all other embodiments obtained by those skilled in the art without creative work belong to a scope of a protection of the present application.

In descriptions of the present application, it should be understood that orientations or positional relationships indicated by terms “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, and “anti-clockwise”, etc, are based on orientations or positional relationships shown in attached drawings, which is only for a convenience of describing the present application and simplifying the descriptions, rather than indicating or implying that devices or elements referred to must have a specific orientation and a structure and an operation in a specific orientation, therefore, it cannot be understood as a limitation of the present application. In addition, the terms “first” and “second” are only used for descriptive purposes and cannot be understood as indicating or implying relative importance or implicitly indicating a number of indicated technical features. Thus, features defining “first” and “second” may explicitly or implicitly include one or more of the features. In the descriptions of the present application, “multiple” means two or more, unless otherwise expressly and specifically defined.

In the description of the present application, it should be noted that unless otherwise clearly specified and limited, terms “installation”, “link”, and “connection” should be understood in a broad sense, for example, it can be a fixed connection, a removable connection, or an integrated connection; it can be a mechanical connection, an electrical connection, or a mutual communication; it can be directly connected or indirectly connected through an intermediate medium; or, it can be a connection relationship within two elements or an interaction relationship between two elements. For those skilled in the art, specific meanings of the above terms in the present application can be understood according to specific circumstances.

In the present application, unless otherwise expressly provided and limited, a first feature is disposed “above” or “below” a second feature may include a direct contact between the first feature and the second feature, or a contact through another feature apart from the first feature and the second feature rather than a direct contact between the two. Moreover, the first feature is disposed “on”, “above”, and “on a surface of” the second feature including that the first feature is disposed directly above and obliquely above the second feature, or only indicates that a horizontal height of the first feature is higher than a horizontal height of the second feature. The first feature is disposed “up”, “below”, and “under” the second feature including that the first feature is directly below and obliquely below the second feature, or only indicates that the horizontal height of the first feature is less than the horizontal height of the second feature.

A following disclosure provides many different embodiments or examples to implement different structures of the present application. In order to simplify the disclosure of the present application, components and settings of specific examples are described below. Of course, they are merely examples and are not intended to limit the present application. In addition, the present application can repeat reference numbers and/or reference letters in different examples for a purpose of simplification and clarity, which does not indicate relationships among various embodiments and/or settings discussed. In addition, the present application provides examples of various specific processes and materials, but those skilled in the art can be aware of applications of other processes and/or uses of other materials.

In a traditional liquid crystal display (LCD) display device 1′ as shown in FIG. 1, an array substrate 2′ is made slightly larger than a color filter (CF) substrate 3′ disposed on an upper layer to form a step area 4′, and binding pads are disposed on a front side (near a side of the CF substrate) of the array substrate 2′ located in the step area 4′ for binding and connecting with a driving circuit 5′. The step area 4′ is also covered with a sealant 7′, and the sealant 7′ is used for connecting a frame 6′ and the array substrate 2′ and shading the step area 4′. However, an arrangement of the sealant 7′ will cause a frame of a panel to be too wide, which is not conducive to achieving a narrow-frame display. Moreover, after a part of the driving circuit 5′ is bound with the binding pads in the step area 4′, a remaining part of the driving circuit 5′ is bent to a back of the array substrate 2′ from a side of the array substrate 2′. The above design will lead to a risk of extrusion between the driving circuit 5′ and the frame 6′ installed on a side of the panel. In addition, when the LCD display device shown in FIG. 1 is applied to a splicing screen display field, a splicing seam will be too large, thereby affecting an image quality.

In order to solve above technical problems, the present application proposes a display panel, a display device, and a splicing display device, with specific reference to descriptions of following embodiments.

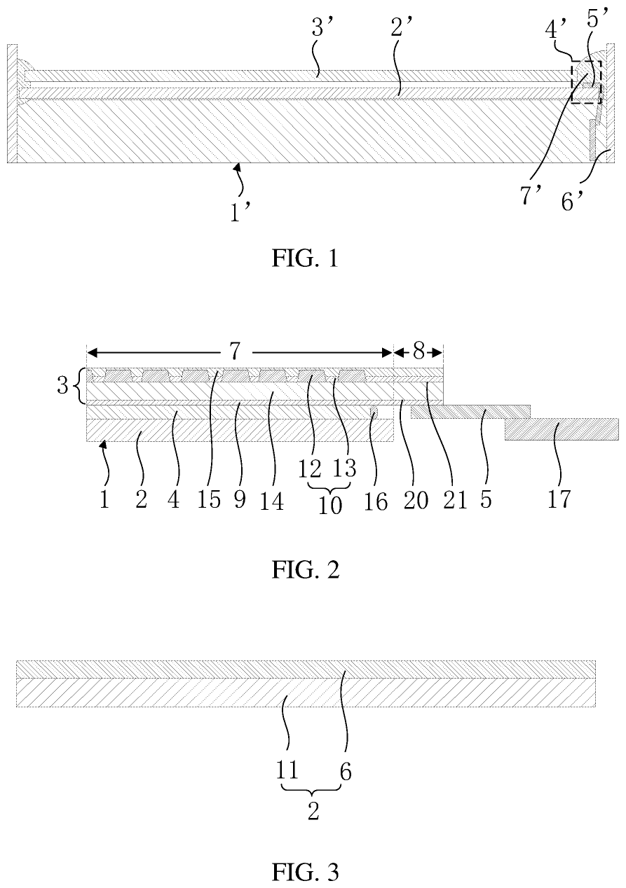

As shown in FIG. 2 and FIG. 3, an embodiment of the present application provides a display panel 1. The display panel 1 includes a first substrate 2, a second substrate 3 disposed opposite to the first substrate 2, a liquid crystal layer 4 sandwiched between the first substrate 2 and the second substrate 3, and a flexible circuit board 5 bound and connected to the second substrate 3. The first substrate 2 includes a common electrode layer 6 disposed at least corresponding to the liquid crystal layer 4; the second substrate 3 includes a first region 7 and a second region 8 located at a side of the first region 7, and includes an array layer 9 located in the first region 7 and the second region 8 and a color filter layer 10 located on a side of the array layer 9 away from the liquid crystal layer 4; the first substrate 2 is disposed corresponding to the first area 7. The flexible circuit board 5 is bound and connected to the array layer 9 located in the second area 8, and the flexible circuit board 5 is located on a side of the array layer 9 close to the liquid crystal layer 4.

It can be understood that the common electrode layer 6 and the array layer 9 are respectively disposed on two sides of the liquid crystal layer 4 for generating an electric field to deflect liquid crystals to achieve a display function.

Specifically, as shown in FIG. 3, the first substrate 2 further includes a substrate 11, such as a glass substrate 11; the common electrode layer 6 is located on the substrate 11, and the common electrode layer 6 is located on a side of the substrate 11 close to the liquid crystal layer 4.

Specifically, the array layer 9 includes a plurality of pixel driving circuit units (not shown) located in the first region 7 and distributed in an array and a pad group located in the second region 8 and electrically connected to the plurality of pixel driving circuit units; the pad group is exposed on the side of the array layer 9 close to the liquid crystal layer 4 and bound and connected to the flexible circuit board 5.

It is understandable that each of the pixel driving circuit units includes at least one thin film transistor.

In a specific embodiment, as shown in FIG. 2, edges of the array layer 9 and the color filter layer 10 are aligned, and a side of the color filter layer 10 away from the array layer 9 is a display surface.

Specifically, the color filter layer 10 includes a plurality of color resist units 12 located in the first region 7 and disposed in an array and a light shielding layer 13 located in the first region 7 and the second region 8 and located between any two adjacent ones of the color resist units 12. It can be understood that the light shielding layer 13 of the color filter layer 10 can shade the flexible circuit board 5 and other wirings located in the second area 8, so it is not necessary to add a front frame, a black tape, or a sealant on the color filter layer 10 to shade the second area.

In a specific embodiment, each of the color resist units 12 includes any one of a red color resist (R), a green color resist (G), and a blue color resist (B). For example, every three adjacent ones of the color resist units 12 constitute one pixel unit, and each pixel unit includes the red color resist (R), the green color resist (G), and the blue color resist (B).

In a specific embodiment, the light shielding layer 13 includes a black matrix (BM), but is not limited thereto.

Specifically, as shown in FIG. 2, the second substrate 3 further includes a transparent substrate 14 located between the array layer 9 and the color filter layer 10 and a protective layer 15 located on s side of the color filter layer 10 away from the transparent substrate 14. It can be understood that the array layer 9 and the color filter layer 10 are directly formed on two opposite surfaces of the transparent substrate 14 respectively, for example, the array layer 9 is formed on a first surface 20 and the color filter layer 10 is formed on a second surface 21.

Specifically, materials of the transparent substrate 14 includes glass, but is not limited thereto.

Specifically, a glue frame 16 is further disposed between the first substrate 2 and the second substrate 3 for encapsulating the liquid crystal layer 4 between the first substrate 2 and the second substrate 3.

Specifically, the flexible circuit board 5 includes a chip on film (COF), but is not limited thereto.

In a specific embodiment, a side of the flexible circuit board 5 away from the array layer 9 is also bound with a driving circuit board 17, such as a printed circuit board (PCB).

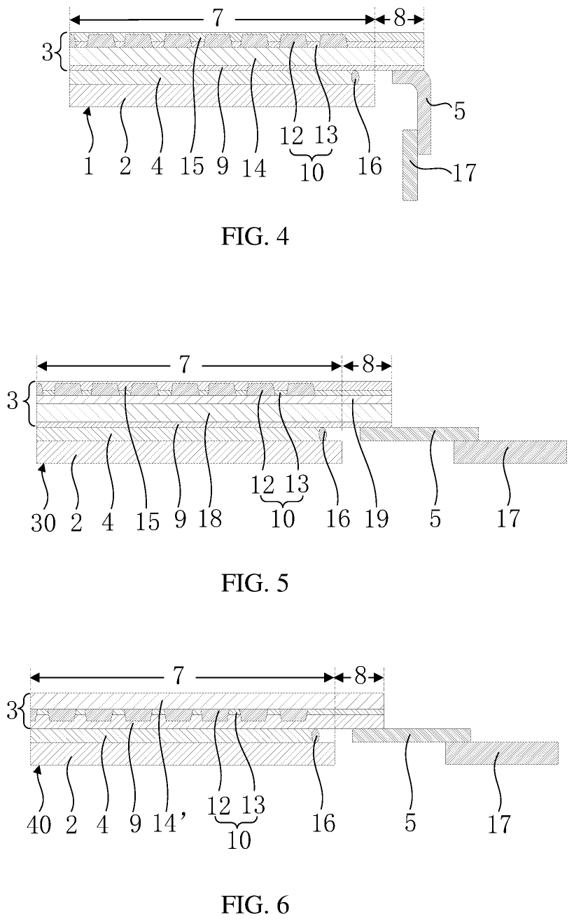

In a specific embodiment, as shown in FIG. 4, a part of the flexible circuit board 5 away from the array layer 9 can be bent along a direction away from the array layer 9.

In the embodiment of the present application, the array layer 9 and the color filter layer 10 are disposed on a same side of the liquid crystal layer 4, and the flexible circuit board 5 is bound on the side of the array layer 9 close to the liquid crystal layer 4, so as to avoid exposing a binding position to the display surface and a side of the display panel 1, thereby avoiding disposing a shielding structure for shading the flexible circuit board 5 located at the binding position (the second area 8) of the display surface of the display panel 1, which can effectively narrow a frame of the display panel 1 visually to achieve a narrow-frame display.

As shown in FIG. 5, an embodiment of the present application further provides a display panel 30, which is different from the previous embodiment in a structure of the transparent substrate. Specifically, in the embodiment of the present application, the transparent substrate is composed of a first transparent substrate 18 and a second transparent substrate 19 superimposed with each other; the first transparent substrate 18 is located between the array layer 9 and the second transparent substrate 19, and the second transparent substrate 19 is located between the first transparent substrate 18 and the color filter layer 10.

Specifically, materials of the first transparent substrate 18 and the second transparent substrate 19 include glass, but are not limited thereto. The array layer 9 is directly formed on the first transparent substrate 18, and the color filter layer 10 is directly formed on the second transparent substrate 19. The second substrate 3 is formed by aligning and attaching (e.g., vacuum attaching) a side of the first transparent substrate 18 away from the array layer 9 and a side of the second transparent substrate 19 away from the color filter layer 10.

It can be understood that when the first substrate 2 and the second substrate 3 are disposed in a box mode, the array layer 9 is disposed close to the first substrate 2.

In the embodiment of the present application, the array layer 9 and the color filter layer 10 are disposed on the same side of the liquid crystal layer 4, and the flexible circuit board 5 is bound on the side of the array layer 9 close to the liquid crystal layer 4, so as to avoid exposing the binding position to the display surface and the side of the display panel 1, thereby avoiding disposing the shielding structure for shading the flexible circuit board 5 located at the binding position (the second area 8) of the display surface of the display panel 1, which can effectively narrow the frame of the display panel 1 visually to achieve the narrow-frame display.

As shown in FIG. 6, an embodiment of the present application further provides a display panel 40, which is different from the previous embodiment in a setting position of the transparent substrate. Specifically, in the embodiment of the present application, a transparent substrate 14′ is located on the side of the color filter layer away from the array layer 9.

Specifically, materials of the transparent substrate 14′ includes glass, but is not limited thereto.

Specifically, the color filter layer and the array layer 9 are sequentially superimposed on the transparent substrate 14′. When the first substrate 2 and the second substrate 3 are disposed in the box mode, the transparent substrate 14′ is inverted so that the array layer 9 is disposed close to the first substrate 2.

In the embodiment of the present application, the array layer 9 and the color filter layer 10 are disposed on the same side of the liquid crystal layer 4, and the flexible circuit board 5 is bound on the side of the array layer 9 close to the liquid crystal layer 4, so as to avoid exposing the binding position to the display surface and the side of the display panel 1, thereby avoiding disposing the shielding structure for shading the flexible circuit board 5 located at the binding position (the second area 8) of the display surface of the display panel 1, which can effectively narrow the frame of the display panel 1 visually to achieve the narrow-frame display.

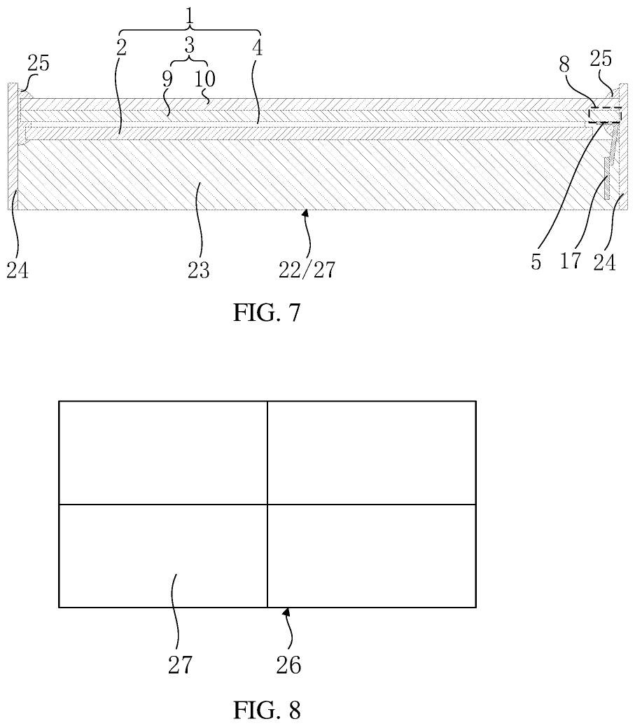

As shown in FIG. 7, an embodiment of the present application further provides a display device 22, the display device 22 includes the display panel 1 (or 30, 40) described in any one of the previous embodiments, a backlight module 23, and a frame 24. The backlight module 23 is located on a side of the first substrate 2 away from the second substrate 3; a part of the flexible circuit board 5 away from the array layer 9 is bent to be fixedly connected to the backlight module 23; the frame 24 is located on sides of the display panel 1 and the backlight module 23 and is fixedly connected to the corresponding display panel 1 (or 30, 40) and the backlight module 23. Of course, the frame 24 can also be located at a bottom of the backlight module 23, which is not limited here.

Specifically, the display device 22 further includes a sealant 25 disposed at least between the display panel 1 (or 30, 40) and the frame 24. Specifically, the sealant 25 is disposed along an edge of the display panel 1 (or 30, 40). It is understandable that the sealant 25 partially covers the second area 8.

Compared with the sealant 7′ of the traditional LCD display device 1′ shown in FIG. 1, the sealant 25 located in the second area 8 in the embodiment of the present application has a smaller width and has less impact on a realization of the narrow-frame.

In the embodiment of the present application, the array layer 9 and the color filter layer 10 are disposed on the same side of the liquid crystal layer 4, and the flexible circuit board 5 is bound on the side of the array layer 9 close to the liquid crystal layer 4, so as to avoid exposing the binding position to the display surface and the side of the display panel 1 (or 30, 40). On one hand, it can avoid bending the flexible circuit board 5 to the side of the display panel 1 (or 30, 40), so as to avoid a risk of extrusion between the flexible circuit board 5 and the frame 24, thereby improving a yield and stability of the display device 22; on the other hand, it can avoid disposing the shielding structure (such as the front frame, the black tape, or the sealant) for shading the flexible circuit board 5 located at the binding position of the display surface of the display panel 1 (or 30, 40), so as to effectively narrow a frame of the display device 22 to achieve the narrow-frame display.

As shown in FIG. 7 and FIG. 8, an embodiment of the present application further provides a splicing display device 26, and the splicing display device 26 includes a plurality of splicing monomers 27 spliced together. Specifically, a structure of a splicing monomer 27 is same as a structure of the display device 22 in the previous embodiment, and the structure shown in FIG. 7 can be referred to.

It can be understood that each of the splicing monomers 27 includes the display panel 1 (or 30, 40) described in the above embodiment and the backlight module 23 and the frame 24 disposed corresponding to the display panel 1 (or 30, 40).

Specifically, the backlight module 23 is located on a side of a corresponding first substrate 2 away from the second substrate 3; the part of the flexible circuit board 5 away from the array layer 9 is bent to be fixedly connected to a corresponding backlight module 23; the frame 24 is located on sides of a corresponding display panel 1 and a corresponding backlight module 23 and is fixedly connected to sides of the corresponding display panel 1 (or 30, 40) and the corresponding backlight module 23.

Specifically, the splicing monomer 27 further includes at least the sealant 25 disposed between the display panel 1 (or 30, 40) and the frame 24. Specifically, the sealant 25 is disposed along the edge of the display panel 1 (or 30, 40). It is understandable that the sealant 25 partially covers the second area 8.

Compared with the sealant 7′ of the traditional LCD display device 1′ shown in FIG. 1, the sealant 25 located in the second area 8 in the embodiment of the present application has a smaller width and has less impact on the realization of the narrow-frame, which can reduce a splicing seam between two adjacent ones of the splicing monomers 27.

Of course, in other embodiments, the frame 24 between any two adjacent ones of the splicing monomers 27 can be cancelled, and sides of at least two display panels 1 (or 30, 40) can be spliced directly to further reduce the splicing seam.

In the embodiment of the present application, the array layer 9 and the color filter layer 10 are disposed on the same side of the liquid crystal layer 4, and the flexible circuit board 5 is bound on the side of the array layer 9 close to the liquid crystal layer 4, so as to avoid exposing the binding position to the display surface and the side of the display panel 1 (or 30, 40). On one hand, it can avoid bending the flexible circuit board 5 to the side of the display panel 1 (or 30, 40), so as to avoid the risk of extrusion between the flexible circuit board 5 and the frame 24, thereby improving a yield and stability of the splicing monomer 27; on the other hand, it can avoid disposing the shielding structure (such as the front frame, the black tape, or the sealant) for shading the flexible circuit board 5 located at the binding position of the display surface of the display panel 1 (or 30, 40), so as to effectively narrow a frame of the splicing monomer 27, thereby effectively reducing the splicing seam to improve a display effect.

In the above embodiments, the descriptions of each embodiment has its own emphasis. For parts not detailed in one embodiment, please refer to relevant descriptions of other embodiments.

The above describes the display panel, the display device, and the splicing display device provided by the embodiments of the present application in detail. In this paper, specific examples are applied to elaborate a principle and an implementation mode of the present application. The descriptions of the above embodiments are only used to help understand the technical schemes and a core idea of the present application. Those of ordinary skill in the art should understand that they can still modify the technical schemes recorded in the above embodiments, or equivalent replace some of the technical features; however, these modifications or substitutions do not separate an essence of a corresponding technical scheme from a scope of the technical scheme of each embodiment of the present application.

What is claimed is:

1. A display panel, comprising a first substrate, a second substrate disposed opposite to the first substrate, a liquid crystal layer sandwiched between the first substrate and the second substrate, and a flexible circuit board bound and connected to the second substrate;
wherein the first substrate comprises a common electrode layer disposed at least corresponding to the liquid crystal layer; the second substrate comprises a first area and a second area located at a side of the first area, and comprises an array layer located in the first area and the second area and a color filter layer located on a side of the array layer away from the liquid crystal layer; the first substrate is disposed corresponding to the first area; and
the flexible circuit board is bound and connected to the array layer located in the second area, and the flexible circuit board is located on a side of the array layer close to the liquid crystal layer.

2. The display panel according to claim 1, wherein the second substrate further comprises a transparent substrate located between the array layer and the color filter layer.

3. The display panel according to claim 2, wherein the transparent substrate comprises a first transparent substrate and a second transparent substrate superimposed with each other; the first transparent substrate is located between the array layer and the second transparent substrate, and the second transparent substrate is located between the first transparent substrate and the color filter layer.

4. The display panel according to claim 2, wherein the display panel further comprises a protective layer located on a side of the color filter layer away from the transparent substrate.

5. The display panel according to claim 1, wherein the second substrate further comprises a transparent substrate located on a side of the color filter layer away from the array layer.

6. The display panel according to claim 1, wherein the color filter layer comprises a plurality of color resist units disposed in an array in the first area and a light shielding layer located in the first area and the second area and located between any two adjacent ones of the color resist units.

7. A display device, comprising the display panel according to claim 1 and a backlight module; wherein the backlight module is located on a side of the first substrate away from the second substrate; a part of the flexible circuit board away from the array layer is bent to fixedly connect to the backlight module.

8. The display device according to claim 7, wherein the display device further comprises a frame located on sides of the display panel and the backlight module, and a sealant located between the display panel and the frame; the sealant partially covers the second area.

9. The display device according to claim 7, wherein the second substrate further comprises a transparent substrate located between the array layer and the color filter layer.

10. The display device according to claim 9, wherein the transparent substrate comprises a first transparent substrate and a second transparent substrate superimposed with each other; the first transparent substrate is located between the array layer and the second transparent substrate, and the second transparent substrate is located between the first transparent substrate and the color filter layer.

11. The display device according to claim 9, wherein the display panel further comprises a protective layer located on a side of the color filter layer away from the transparent substrate.

12. The display device according to claim 7, wherein the second substrate further comprises a transparent substrate located on a side of the color filter layer away from the array layer.

13. The display device according to claim 7, wherein the color filter layer comprises a plurality of color resist units disposed in an array in the first area and a light shielding layer located in the first area and the second area and located between any two adjacent ones of the color resist units.

14. A splicing display device, comprising a plurality of splicing monomers spliced together; each of the splicing monomers comprising the display panel according to claim 1 and a backlight module corresponding to the display panel;
wherein the backlight module is located on a side of a corresponding first substrate away from the second substrate; a part of the flexible circuit board away from the array layer is bent to fixedly connect to the corresponding backlight module.

15. The splicing display device according to claim 14, wherein one of the splicing monomers further comprises a frame located on sides of the display panel and the backlight module, and a sealant located between the display panel and the frame; the sealant partially covers the second area.

16. The splicing display device according to claim 14, wherein the second substrate further comprises a transparent substrate located between the array layer and the color filter layer.

17. The splicing display device according to claim 16, wherein the transparent substrate comprises a first transparent substrate and a second transparent substrate superimposed with each other; the first transparent substrate is located between the array layer and the second transparent substrate, and the second transparent substrate is located between the first transparent substrate and the color filter layer.

18. The splicing display device according to claim 16, wherein the display panel further comprises a protective layer located on a side of the color filter layer away from the transparent substrate.

19. The splicing display device according to claim 14, wherein the second substrate further comprises a transparent substrate located on a side of the color filter layer away from the array layer.

20. The splicing display device according to claim 14, wherein the color filter layer comprises a plurality of color resist units disposed in an array in the first area and a light shielding layer located in the first area and the second area and located between any two adjacent ones of the color resist units.
